(19) United States
(12) Patent Application Publication
(10) Pub. No.: US 2007/0175192 A1
(43) Pub. Date: Aug. 2, 2007

(54) Pleated hybrid air filter

(75) Inventors: Shahriar Nick Niakan, Anaheim Hills, CA (US); Christopher C. Beau, Murrieta, CA (US)

Correspondence Address: CROCKETT & CROCKETT, 24012 CALLE DE LA PLATA, SUITE 400, LAGUNA HILLS, CA, 92653, US

(73) Assignee: Advanced Flow Engineering, Inc.

(21) Appl. No.: 11/346,480

(22) Filed: Feb. 1, 2006

(51) Int. Cl. B01D 50/00

(52) U.S. Cl. 55/486

(57) ABSTRACT

An air filter may include a synthetic foam filter region, and a natural fiber filter media region, having pileous, absorbent, wickable natural fibers. The foam filter region and the natural fiber filter region are supported between pleated influent and effluent mesh layers. Alternatively, a synthetic fiber filter media region having absorbent spunbond polyester filters may also be included. Oil may also be disposed in one of more of the filter media reqions. Fiber regions may also have layers disposed in gradient density arrangement.

### FIELD OF THE INVENTIONS

The inventions described below relate the field of air filters and air cleaners and more specifically to pleated air filters combining natural and synthetic materials.

### BACKGROUND OF THE INVENTIONS

Most people are familiar with air filters used in their cars. These filters are essential to proper operation of the engine, and help extend the life of the engine and its components. Automotive air filters must be replaced periodically because they become clogged and thus inhibit the flow of air into the engine. To the typical consumer, the air filter is cheap, and its replacement is a small additional bother that is handled along with oil changes. However, in dusty environments, high performance applications, industrial and farming applications, the cost of air filters and the burden of replacement may be significant, and a significant increase in filter performance and lifespan can be very valuable.

The air available to the typical automotive or industrial combustion engine always often carries some dirt and debris, or particulate material. Particulate material can cause substantial damage to the internal components of the particular combustion system if taken into the engine. The function of the air intake filter is to remove the particulate matter from the intake air, so that clean air is provided to the engine. The intake air stream flows from the influent, or “dirty,” side of the filter to the effluent, or “clean,” side of the filter, with the air filter extracting the unwanted particles via one or more filter media layers. Filter media are selected to trap particles exceeding a particular size, while remaining substantially permeable to air flow.

The choice of filter media which has a high filter efficiency (that is, it removes a high percentage of the particulate material in the intake air) is important because any particulate matter passing through the filter will harm the engine. The choice of filter media which is permeable to air flow is important because the interposition of the filter into the intake air stream can impede air flow, and this decreases engine efficiency, horsepower, torque, and fuel economy. It is desirable, then, that an air filter effect both a minimal reduction in airflow as well as a minimal increase in the resistance, or restriction, to air flowing into the engine. The choice of filter media that can effectively filter air for extended periods without becoming clogged is also important, so that operation of the engine need not be interrupted frequently to change the air filter.

The features and filter design choices that lead to improvements in one of these parameters can lead to losses in the other performance parameters. Thus, filter design involves trade-offs among features achieving high filter efficiency, and features achieving a high filter capacity and concomitant long filter lifetime. As used herein, filter efficiency is the propensity of the filter media to trap, rather than pass, particulates. Filter capacity is typically defined according to a selected limiting pressure differential across the filter, typically resulting from loading by trapped particulates. For systems of equal efficiency, a longer filter lifetime is typically directly associated with higher capacity, because the more efficiently a filter medium removes particles from a fluid stream, the more rapidly that filter medium approaches the pressure differential indicating the end of the filter medium life.

A particular filter medium can be very efficient, with a single layer removing a large percentage of the particles entrained in the fluid, for example, by collecting particles as a dust cake on the dirty side of the filter. Such “surface-loading” media includes paper and dense mats of cellulose fibers, with small pores. Initially, the dust cake can increase filter efficiency by itself operating as a filter. Over time, the dust cake tends to shorten the media lifetime, as more trapped particles occlude the filter medium surface pores, resulting in increased differential pressure across the filter. Depending upon the airflow through, and operating conditions of, the filter, a high-efficiency surface-loading filter medium can quickly reach a lifetime load. To extend filter lifetime, filter media can be pleated, providing greater filtering surface area.

Adding a foam prefilter to a pleated paper filter may also extend the useable life of an air filter. However conventional prefilters are not pleated like the primary filter, thus the prefilter has a limited surface area and is thus a limiting factor in the life of the combination filter. What is needed is a technique for pleating and combining one or more foam prefilters with other pleated media to provide air filtration.

### SUMMARY

An air filter may include a synthetic foam filter region, and a natural fiber filter media region. The foam filter region and the natural fiber filter region are supported between pleated influent and effluent mesh layers. Alternatively, a synthetic fiber filter media region having absorbent spunbond polyester filters may also be included. Oil may also be disposed in one of more of the filter media reqions. Fiber regions may also have layers disposed in gradient density arrangement.

The devices describe below provide for an extremely long-lived pleated engine air filter which exhibits high efficiency and high capacity. The hybrid filter includes one or more influent layers of synthetic foam and two or more layers of porous natural fiber filter media receiving the prefiltered fluid stream. The synthetic foam layer or layers may be formed from open cell or reticulated polyurethane or polyester urethane foam. The natural fiber filter media is formed from pileous, absorbent, and wickable natural fibers, including one or more layers of cotton mesh.

The foam filter media region traps a first portion of the particles in the influent fluid stream while the influent fluid stream passes substantially unimpaired through the pores, and creates a filtered fluid stream having therein a second portion of the particles. The natural fiber filter media region receives the filtered fluid stream and traps a substantial amount of the second portion of particles in the filtered fluid stream, while the filtered fluid stream passes substantially unimpaired through the pores, and releasing a filtered effluent fluid stream. The filter also includes two structural mesh layers with the foam and natural fiber filter media being interposed between them. The natural fiber filter media may also be wetted with a small amount of oil to enhance its efficiency.

Alternatively, the filter may have one or more influent foam filter layers adjacent two or more natural fiber layers, the natural fiber layers may be adjacent one or more synthetic fiber layers that form the effluent layers of the hybrid pleated filter. The hybrid media filter layers may also be sandwiched between pleated structural mesh layers.

A pleated air filter according to the present disclosure includes an influent mesh layer and a corresponding effluent mesh layer, one or more layers of synthetic foam between the influent mesh layer and the effluent mesh layer, and one or more layers of natural fiber filter media formed from a pileous, absorbent, and wickable natural fiber between the one or more layers of synthetic foam and the effluent mesh layer.

Alternatively, a pleated air filter according to the present disclosure may include an influent mesh layer and a corresponding effluent mesh layer for supporting filter media, one or more layers of synthetic foam between the influent mesh layer and the effluent mesh layer, one or more layers of cotton fiber filter media formed from a pileous, absorbent, and wickable natural fiber between the one or more layers of synthetic foam and the effluent mesh layer, one or more layers of spunbond polyester fiber filter media between the one or more layers of cotton fiber filter media and the effluent mesh layer, and an efficacious amount of oil may be optionally disposed in the one or more layers of synthetic foam and the one or more layers of cotton fiber filter media.

### BRIEF DESCRIPTION OF THE DRAWINGS

FIG. 1 is a cross-section of multiple layer air filter media according to the present disclosure.

FIG. 2 is a cross-section of a pleated hybrid filter according to the present disclosure.

FIG. 3 is a perspective view of a pan air filter using the filter media of FIG. 2.

FIG. 4 is a perspective view of a conical air filter using the filter media of FIG. 2.

### DETAILED DESCRIPTION OF THE INVENTIONS

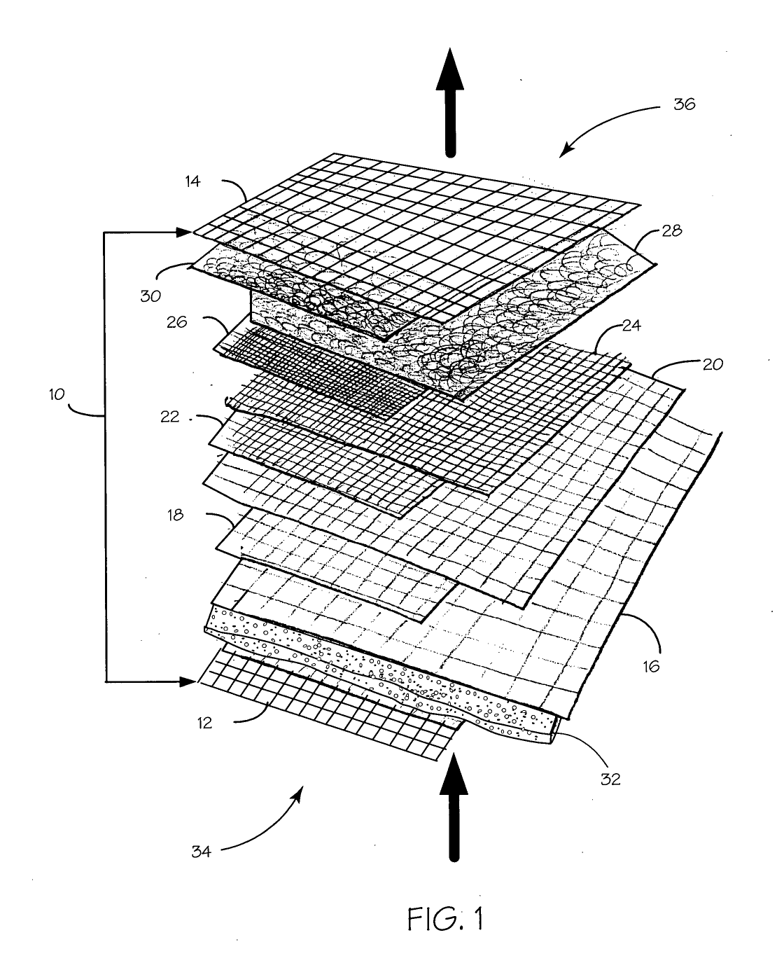

FIG. 1 is a cross section of multiple layer, hybrid, air filter media 10 which comprises several filter layers 16, 18, 20, 22, 24, 26, 28 and 30 sandwiched or interposed between structural mesh layers 12 and 14. In this illustration, the “dirty,” or influent, side of media 10 is the side of the filter that is upstream in the flow path of air such as side 34. The “clean,” or effluent side of the media is the side of the filter that is downstream such as side 36. The air flowing out of effluent side 36 is provided to an engine or other suitable device.

Structural mesh layers 12 and 14 can be made of a lightweight aluminum mesh, although layers 12 and 14 also may be fabricated from various metals, plastics and polymers. An exemplary aperture count for layers 12 and 14 can be approximately 18×14 openings per inch, although other aperture counts may be suitable. In addition, it may be desirable that mesh layers 12 and 14 be epoxy-coated in order to afford enhanced protection to filter media 10. Although both layers 12 and 14 may be so protected, it may be particularly desirable to epoxy-coat influent mesh layer 12, guarding the thin mesh against granulates, foreign objects, and injurious incidents. The fiber layers 16, 18, 20, 22, 24, 26, 28 and 30 may include natural fibers and/or manufactured or synthetic fibers. As illustrated in FIG. 1, fiber layers 16, 18, 20, 22, 24 and 26 are natural fiber layers, and fiber layers 28 and 30 are manufactured fiber layers. The natural fiber layers are most conveniently cotton, but other natural fibers such as silk, jute, ramie, flax, cellulosic fibers, wool and the like may be used. The manufactured fiber layers are most conveniently made of synthetic fibers, such as spunbond polyester, but can also be made of other synthetic fabrics (nylon, olefin, acrylic, etc.), polymers, glasses, and modified or transformed natural polymers, and modified cellulosic fibers.

Natural fiber layers 16, 18, 20, 22, 24, and 26 establish a natural fiber filter media region of filter media 10, and the synthetic fiber layers 28 and 30 establish a synthetic fiber filter media region of filter media 10. In filter media 10, it is apparent that synthetic fiber filter media region is in fluid communication with the natural fiber filter media region. As the influent fluid stream passes through the natural fiber filter media region a first portion of the particles in the stream become trapped, so that the synthetic fiber filter media region receives a filtered fluid stream with a residual second portion of the particles therein, trapping a substantial amount of the second portion of particles. In filter media 10, the constituent filter media of both the natural fiber filter media region and the synthetic fiber filter media region are selected with pores or openings formed such that, despite the fibers therein effecting trapping of particles, the fluid stream is able to pass substantially unimpaired through the pores.

In general, where natural fibers are used, such as with fiber layers 16, 18, 20, 22, 24 and 26, it may be desirable to use cotton mesh, because the constituent cotton fibers tend to be both highly pileous (that is, each cotton thread has many small hairy fibers sticking out of it) and highly wickable. Cotton meshes can include gauze, cheesecloth and spun laced fabric. Gauze, cheesecloth and similar fabrics may be characterized as thin, open-meshed, low thread-count, plain weave, soft fabric. An example of a cotton gauze that may be advantageously employed in filter media 10 is “absorbent gauze,” as described in the United States Pharmacopoeia (USP), which must meet specific standards of construction, chemical purity and absorbency.

Another exemplary cotton mesh that can be used in filter media 10 is spun-lace, or hydroentangled, non-woven cotton fabric. Spun-lace cotton is a non-woven fabric produced using high-velocity jets or curtains of water to entangle fibers into fiber bundles, in a repeating web-like pattern, thereby forming a strong fabric. This technique preserves the pure fiber condition, which is conducive to making high absorbency products, substantially free of binders and chemical impurities. Spun-lace cotton fabric can be engineered to exhibit structural characteristics tailored to the medium application.

For example, with hydro-entangled fabric, fiber bundles may be designed with high-density areas that provide a fine capillary structure and allows a rapid absorbency rate. Moreover, the uniformity of the fabric pattern, the open spaces, the stability of fabric openings, the various physical and functional characteristics and the open pattern imparted to the fabric can be different from those obtained with plain-woven gauze.

Returning to FIG. 1, fiber layers 16, 18, 20, 22, 24 and 26 are provided with increasing thread count or weave fineness, such that fiber layer 16, having the coarsest, or most open weave, mesh, is disposed in proximate contact with foam prefilter layer 32, and fiber layer 26, having the highest thread count and the finest, or least open weave of the selected fiber meshes, adjacent to or, alternatively, in proximate contact with, clean side mesh layer 14. Interposed between layers 16, 26 can be additional fiber layers, wherein layer 18 is less coarse than layer 16, and layer 24 is coarser than layer 26. In this manner, a region of natural fiber mesh, gradient-density, depth-loading filter media can be constructed in media 10.

The synthetic fiber layers 28 and 30 most conveniently comprise spun-bond polyester webs, meshes or mats, which are prepared from drawn, randomly-laid, and thermally-, or ultrasonically-bonded continuous polyester filaments. Preferred varieties of spun-bond filtration media are fabricated without binders, thereby minimizing contamination of air flowing through the media. Exemplary spun-bond polyester fibers include Reemay® 2024 medium, being about 12 mils thick with a basis weight of about 71 g./sq. m.; and Reemay® 443 medium, being about 17 mils thick with a basis weight of about 10 g./sq. m. Both media are formed from straight, trilobal polyester fibers having a diameter of about 23 microns. Reemay® media are produced by Reemay, Inc., Old Hickory, Tenn., and are well-known in the fluid filtration art. Any suitable synthetic fibers may be used, with absorbent, efficient, fibers having a low contaminant content especially desirable.

As illustrated in FIG. 1, synthetic filter media layers may be chosen to provide a gradient-density region. Similar to the arrangement of natural fiber filter layers, less dense layers can be disposed closer to the influent side of the filter, with more dense layers being disposed closer to the effluent side, or in proximate contact with metal mesh layer 14. In FIG. 1, synthetic fiber layer 28 is selected to be less dense than synthetic fiber layer 30, and can be interposed between the finest natural fiber layer 26 and the finest, and most dense, synthetic fiber layer 30. Layer 30 is, in turn, disposed in proximate contact with effluent metal wire mesh 14. Multiple layers 28 and 30 thus provide a region of synthetic fiber mesh, gradient-density, depth-loading filter media.

In certain applications, it may be desirable to provide multiple, perhaps alternating, regions of synthetic fiber mesh, depth-loading filter media, of uniform density, gradient density, or an efficacious combination thereof.

Filter media 10 removes a wide range of particle sizes from an influent air stream. Larger particles can be physically trapped by impacting upon, or by being attracted to, the foam prefilter layer 32 and then the fabric mesh fibers or to the pili, as individual particles or agglomerations of particles. Particle bridge formations tend to be disrupted by the flowing air, causing growing particulate dendrites and agglomerations to collapse and fall through to the next the layer of filter material. Smaller particles can be induced to move chaotically by the forces in the air stream, such as velocity changes, pressure changes, turbulence caused by other particles, and interaction with the air molecules. Thus, despite being much smaller than the individual filter media pores and openings, these particles do not follow the air stream, with their erratic motion causing collisions with the filter media fibers and agglomerations of other particles. Therefore, by judiciously selecting the physical characteristics and arrangement of the natural and synthetic filter media layers, a filter constructed according to the principles herein, can provide a high capacity, high efficiency filtration even in harsh operating environments under high airflow conditions.

Optionally, filter media may be treated with oil or other tacking agents that may extend the lifespan of the filter described above. One or more filter layers may be wetted with oil. Because cotton fibers are generally oleophilic, the fibers absorb oil, the oil tends to be thoroughly wicked and absorbed by the fine pili, or hairs, of the cotton fibers. Foam media also holds oil well in the open cell structure. It is desirable to merely wet, and not soak, the filter media 10 with oil, because oil soaking which completely fills the interstices of the foam and between the fabric threads with oil increases resistance to airflow. By selecting the type and the composition of the oil employed during oil wetting, the individual cotton fiber pili tend to swell, and present an advantageously larger surface area to the flowing air, further enhancing the performance of filter media 10. Suitable tacking agents for wetting the filter media include mineral oil, engine oil, and other tacking agents, and combinations of these components. Suitable tacking agent may also be conveniently applied using aerosol spray, or a liquid squeeze bottle, such as AFE air filter oil available from Advanced Flow Engineering of Corona, Calif.

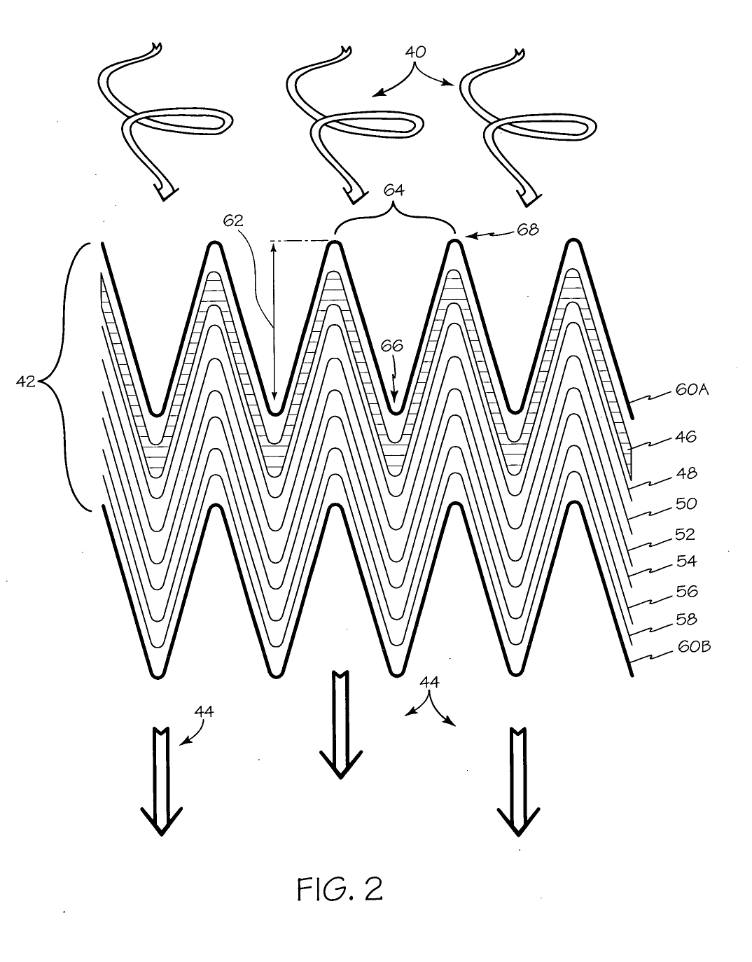

FIG. 2 is a cross section view of a pleated multiple layer filter media in which particulate-bearing influent air stream 40 is cleaned by filter media 42 to provide a substantially particulate-free effluent air stream 44. The filter media 42 is pleated, and is formed by interposing foam layer 46 and one or more fiber layers, such as natural fiber-based filter layers 48, 50, 52, 54 and/or synthetic fiber layers 56 and 58, between pleated structural mesh layers 60A, 60B. The mesh layers 60A and 60B are analogous to mesh layers 12 and 14 in FIG. 1.

Filter media 42 includes a region of synthetic, open cell foam media represented by foam layer 46, a region of natural fiber mesh depth-loading filter media, represented by cotton mesh layers 48, 50, 52 and 54, and a region of synthetic fiber mesh, depth-loading filter media, represented by spunbond polyester fiber webs 56 and 58. Although either, or both, of the fibrous filter media regions can be of uniform density filter fiber layers, it may be desirable in certain circumstances to supply filter media 42 with gradient-density-type regions both in the natural fiber region and in the synthetic fiber region. Accordingly, the weave of cotton mesh layer 48 is generally more coarse than the weave of cotton mesh layer 50 which is generally more coarse than the weave of natural mesh layer 52 and so on. In addition, the more dense synthetic fiber layers such as layers 56 and 58 can be disposed in proximate contact with effluent support mesh 60B. Moreover, the less dense synthetic fiber layer 56 can be interposed between finer cotton mesh layer 54 and the more dense, synthetic fiber layer 58.

Similarly, filter media 42 may also have two or more layers of synthetic foam. Each layer may have different density, with the less dense layer adjacent support mesh 60A and the densest foam layer adjacent one or more fiber layers such as layer 48.

The dimensions of each pleat such as pleat 64 may be controlled to optimize the performance of a foam pleated air filter. Pleat depth 62 may vary from about 10 mm to 50 mm, depending on available space. Radius of curvature of trough 66 and peak 68 may be selected to optimize the surface area of a filter using media 42. For example, pleated troughs such as trough 66 may have a radius of curvature of about 1 mm, and peaks such as peak 68 may have a radius of curvature of 2.5 mm. It is desirable to make the filter media with about 2 to 5 pleats per inch.

The filter media can be employed is any type of air filter, including flat pan filters, cylindrical filters, cone filters, and ring filters. The filter media is cut, pleated, and formed to the desired shape, and the edges of the filter media may be lapped for cylindrical or conical filters or fused into a frame which mates the filter media with the intake air filter housing or air intake tube of the engine with which the filter is used. The frame serves as the seal between the filter and the air intake system of the engine, and may be made of compliant polyurethane or other suitable elastomer.

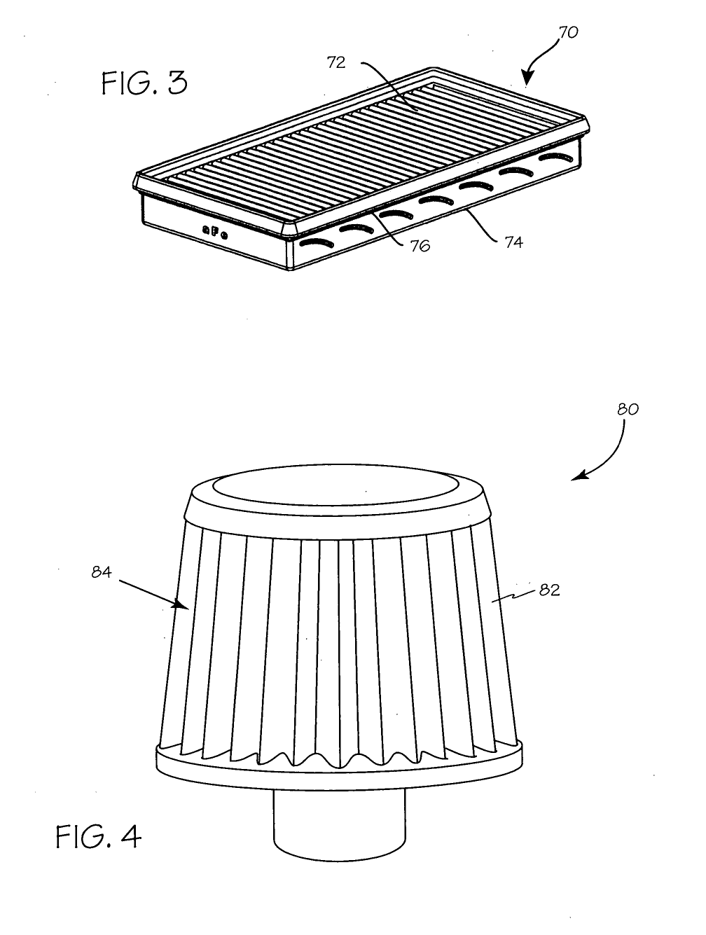

FIG. 3 shows a pan filter 70 provided with the pleated filter media 72 cut to fit an air filter housing in a conventional automobile, held within the frame 74 which in turn is provided with a sealing edge 76 for providing an air-tight seal with the air filter housing.

Referring now to FIG. 4, conical filter 80 includes pleated media 82 with a foam layer adjacent ingress side 84.

An air filter as described above may be washable and reusable. Both the natural fiber and synthetic fiber regions can be cleaned with a simple cleaning solution and water, thereby substantially removing the particle load that accrued over the period during which the filter was in use, or cycle lifetime. In configurations employing optional oil wetting, an efficacious amount of suitable oil, such as a mineral oil, may be applied after cleaning to re-wet the oleophilic portions of the filter media. Oil may be applied using any suitable technique such as for example aerosol spray, or liquid squeeze bottles or other. The filters described above can have a cumulative lifetime of, for example, between 10 to 20 cycle lifetimes. The cumulative lifetime of the filter often can be comparable to the lifetime of the combustion engine in which it is used.

In its typical use, the air filter described above replaces typical automotive air filters and combustion engine air filters. The filter may be cleaned periodically, optionally coated with oil and placed back in service after repeated uses. The high capacity of the air filter provides for longer intervals between servicing than can be tolerated with stock air filters.

The components of the air filter described above can be varied, while still obtaining the advantages of the varying layer density. The structural mesh, for example, can comprise wire screen, expanded metal mesh, woven and welded metal mesh, and perforated metal sheets. The particular configuration of the mesh structure, including mesh thickness, rigidity, malleability, mesh opening size and shape, and so forth, can be selected to provide mesh layers 12 and 14 with the desired physical characteristics, including air permeability, strength, longevity, and shape. For example, mesh layers 12 and 14 be configured such that the mesh openings create an insubstantial contribution to total air flow restriction across filter media 10, yet support and protect the filter medium layers which are sandwiched between the structural mesh layers. The number of natural fiber layers can be varied from the configurations illustrated above. The number of synthetic fiber layers can also be varied from the two-layer construction illustrated above.

Additionally, while the air filter has been described in connection with its application to combustion engines, the filter media may be used in a wider variety of applications, such as air conditioning and air purification for buildings and clean rooms, for cleaning air provided to the intake of air compressors, and for filtering air and gases provided to any industrial system requiring pure air. Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

We claim:

1. A pleated air filter comprising:
a influent mesh layer and a corresponding effluent mesh layer;
one or more layers of synthetic foam between the influent mesh layer and the effluent mesh layer; and
one or more layers of natural fiber filter media formed from a pileous, absorbent, and wickable natural fiber between the one or more layers of synthetic foam and the effluent mesh layer.

2. The air filter of claim 1, wherein the natural fiber is a cotton fiber.

3. The air filter of claim 1 further comprising:
one or more layers of manufactured fiber filter media between the one or more layers of natural fiber filter media and the effluent mesh layer.

4. The air filter of claim 3, wherein the manufactured fiber is a spunbond polyester fiber.

5. The air filter of claim 4, wherein at least one of the one or more natural fiber filter layers is plain-woven cotton gauze.

6. The air filter of claim 4, wherein at least one of the one or more natural fiber filter layers is a non-woven hydroentangled cotton fabric.

7. The air filter of claim 1 further comprising an efficacious amount of oil disposed in the one or more layers of synthetic foam.

8. The air filter of claim 1 further comprising an efficacious amount of oil disposed in at least one of the one or more natural fiber filter layers.

9. The air filter of claim 1 further comprising an efficacious amount of oil disposed in the one or more layers of synthetic foam and the one or more layers of natural fiber filter media.

10. The air filter of claim 2, wherein the one or more layers of natural fiber filter media further comprise:
a first cotton mesh layer having a first cotton mesh density, and a second cotton mesh layer having a second cotton mesh density that is higher than the first cotton mesh density, and the first cotton mesh layer is disposed adjacent the one or more layers of synthetic foam and the second cotton mesh layer between the first cotton mesh layer and the effluent mesh layer.

11. The air filter of claim 3, wherein the one or more layers of manufactured fiber filter media further comprise:
a first manufactured mesh layer having a first manufactured mesh density, and a second manufactured mesh layer having a second manufactured mesh density that is higher than the first manufactured mesh density, and the first manufactured mesh layer is disposed adjacent the one or more layers of natural fiber filter media and the second manufactured mesh layer between the first manufactured mesh layer and the effluent mesh layer.

12. The air filter of claim 11, wherein the manufactured fiber is a spunbond polyester fiber.

13. The air filter of claim 10, wherein at least one of the one or more natural fiber filter layers is plain-woven cotton gauze.

14. The air filter of claim 10, wherein at least one of the one or more natural fiber filter layers is a non-woven hydroentangled cotton fabric.

15. The air filter of claim 10 further comprising an efficacious amount of oil disposed in at least one of the one or more natural fiber filter layers.

16. The air filter of claim 10 further comprising an efficacious amount of oil disposed in the one or more layers of synthetic foam and the one or more layers of natural fiber filter media.

17. A pleated air filter comprising:
an influent mesh layer and a corresponding effluent mesh layer for supporting filter media;
one or more layers of synthetic foam between the influent mesh layer and the effluent mesh layer;
one or more layers of cotton fiber filter media formed from a pileous, absorbent, and wickable natural fiber between the one or more layers of synthetic foam and the effluent mesh layer;
one or more layers of spunbond polyester fiber filter media between the one or more layers of cotton fiber filter media and the effluent mesh layer; and
an efficacious amount of oil disposed in the one or more layers of synthetic foam and the one or more layers of cotton fiber filter media.
